(19) United States
(12) Patent Application Publication
(10) Pub. No.: US 2012/0048401 A1
(43) Pub. Date: Mar. 1, 2012

(54) BALL CHECK VALVE

(76) Inventors: Seiji Yamashita, Miyazaki (JP); Takeshi Iwamoto, Miyazaki (JP)

(21) Appl. No.: 13/256,350

(22) PCT Filed: Mar. 24, 2010
(86) PCT No.: PCT/JP2010/055047

§ 371 Date: Nov. 16, 2011

(30) Foreign Application Priority Data
Mar. 31, 2009 (JP) 2009-05392

(51) Int. Cl. F16K 15/00

(52) U.S. Cl. 137/528

(57) ABSTRACT

A ball check valve that prevents vibration of the ball that occurs when fluids are conducted, so as to limit noise, without reducing the flow rate of the fluid includes a cylindrical valve main body having two opening parts and provided on an inner face with axially oriented elongate protrusions; a holding ring, which is held on the upstream opening part of the valve main body, abutting end faces of the elongate protrusions; a seat ring, which is disposed adjacent to or fitted with the holding ring; and a globular valve element, which is held so as to be able to reciprocate between stop faces on the elongate protrusions and a valve-closed position. When the globular valve element is abutting the stop faces of the elongate protrusions, the relationship between: the area S₁ of a flow path opening formed between an outer circumferential line that is orthogonal to the axis at the center of gravity of the globular valve element and the inner circumferential face of the valve main body; and the area S₂ of a flow path opening that is formed between the holding ring and the globular valve element at a line that connects the center of gravity of the globular valve element and the downstream inner circumferential line of the seat ring or the holding ring is S₂=0.45 S₁ to 0.65 S₁.

### BACKGROUND OF THE INVENTION

The present invention relates to a ball check valve that is used in piping lines in various industries such as in chemical factories, in water supply and sewage, in agriculture and aquaculture, in the field of semiconductor manufacture and in the field of food products; more specifically, the present invention relates to a ball check valve that prevents vibration of the ball that occurs when fluids are conducted, so as to limit noise, without reducing the flow rate of the fluid.

Conventionally, check valves such as shown in FIG. 6 have been available (see JP-2007-155118-A). This comprises a cylindrical first housing 103 that accommodates a valve element 101 at the interior so that it is capable of movement, a retaining part 102 being formed at one end, which prevents the valve element 101 from coming out, and a cylindrical second housing 105, which is fitted at the other end of the first housing 103 so that the axes thereof coincide with each other, and in which an annular valve seat 104 is formed, which has a seating face that receives the valve element 101; between the end faces of the two housings 103, 105, which face each other, an annular first seal member 106 is provided for preventing leaks between the two housings 103, 105; an annular second seal member 107 is provided on the seating face of the valve seat 104 so as to prevent leakage between the valve element 101 and the valve seat 104 when the valve element 101 is seated on the valve seat 104; and a pressing part 108 is provided on either one of the first housing 103 or the second housing 103, so as to press the second seal member 107 toward the seating face.

### SUMMARY OF THE INVENTION

However, with the conventional check valve described above, the fluid flow was easily disturbed when the fluid passed between the inner circumference of the first housing 103 and the valve element 101, which was held by a rib 109, and as the flow disturbance increased with increases in the fluid flow rate, there was a risk of vibration being generated in the valve element 101. This is most likely to occur when the check valve is fitted vertically and flow of the fluid from the bottom to the top constitutes forward flow, so that although the valve element 101 tends to drop downward under its own weight, the upward flow of the fluid pushes the valve element 101 up, so that it rises, whereby the valve element 101 is separated from the second seal member 107 so that the valve element is opened and the area of the opening increases, whereupon the flow of the fluid follows the outer circumferential face of the valve element 101 and flows between the inner circumference of the first housing 103 and the valve element 101, which is held by the rib 109; and thus with increases in the size of the opening between the valve element 101 and the second seal member 107, the majority of the force of the fluid that pushes the valve element 101 upwards tends to spread out toward the exterior in a radial manner, so that it is not possible to achieve a pushing force sufficient to maintain the valve element 101 in contact with the retaining part 102, and thus, with the valve element hovering in the region of the rib 109, it is subjected to the disturbance in the flow of the fluid, and hence vibrates. There was, in particular, a problem in so much as, if the distance that the valve element 101 traveled from the second seal member 107 to the retaining part 102 of the rib 109 was great, after the valve element 101 had been raised, almost all of the force of the fluid that pushed the valve element 101 upward would spread out radially in the outward direction, so that the valve element 101 could not achieve a steady state, and with disturbances in the fluid, the valve element 101 moved within the first housing 103, so that vibration readily occurred. There were problems such as: the problem of reduced flow rates for the fluid flowing through the check valve due to the vibrating valve element 101 impeding the flow of the fluid when the valve element 101 vibrated in the check valve and; the problem of noise being generated due to intermittent impact between the first housing 103 and the valve element 101 as a result of the vibration, which in the worst cases posed the risk of the check valve being damaged by the intermittent bumping of the valve element 101 within the first housing 103; and the problem of abrasive deformation occurring due to the valve element 101 striking the rib 109 as a result of the vibration, posing the risk of fluid leaking through gaps in the area of contact between the valve element 101 and the valve seat 104.

The present invention is a reflection of problems in the prior art such as those described above, and an object thereof is to provide a ball check valve that prevents vibration of the ball that occurs when fluids are conducted, so as to limit noise without reducing the flow rate of the fluid.

Describing the configuration of the ball check valve of the present invention that solves the problems described above, in a ball check valve comprising: a cylindrical valve main body having two opening parts and provided on an inner face with axially oriented elongate protrusions; a holding ring, which is held on the upstream opening part of the valve main body, abutting end faces of the elongate protrusions; a seat ring, which is disposed adjacent to or fitted with the holding ring; and a globular valve element, which is held so as to be able to reciprocate between stop faces on the elongate protrusions and a valve-closed position, at rest in contact with the seat ring, a first characteristic is that, when the globular valve element is abutting the stop faces of the elongate protrusions, the relationship between: the area S₁ of a flow path opening formed between an outer circumferential line that is orthogonal to the axis at the center of gravity of the globular valve element and the inner circumferential face of the valve main body; and the area S₂ of a flow path opening that is formed between the holding ring and the globular valve element at a line that connects the center of gravity of the globular valve element and the downstream inner circumferential line of the seat ring or the holding ring is S₂=0.45 S₁ to 0.65 S₁.

A second characteristics is that a distance m over which the globular valve element can reciprocate is 0.2 L to 0.6 L, with respect to the diameter L of the globular valve element.

A third characteristics is that, when the globular valve element is in the closed position, at rest against the seat ring, the end faces of the elongate protrusions that abut the holding ring are located further upstream in the valve main body than an outer circumferential line that is orthogonal to the axis at the center of gravity of the globular valve element.

A fourth characteristic is that of comprising a pressing ring that threadedly engages on the inner circumferential face of the upstream opening part of the valve main body and holds the holding ring and the seat ring trapped against the end faces of the elongate protrusions.

A fifth characteristic is that of comprising: a flanged short pipe, which is held in a sealed state against the valve main body with the seat ring or the pressing ring therebetween; and a cap nut that fixes the flanged short pipe in place on the valve main body by threadedly engaging on the valve main body.

A sixth characteristic is that an annular fitting part formed at the outer circumferential edge of the seat ring fits in an annular groove formed in a side face of the holding ring, and one end face of the pressing ring, or the flange-side end face of the flanged short pipe, abuts and presses against the seat ring.

A seventh characteristic is that a taper is provided on the inner face of the holding ring, which narrows to less than the diameter or the globular valve element.

An eighth characteristic is that of further comprising: an O-ring fitted in an annular groove that is provided on the end face of the downstream opening part of the valve main body; a flanged short pipe that contacts the valve main body with the O-ring therebetween; and a cap nut that fixes the flanged short pipe in place on the valve main body by threadedly engaging on the valve main body.

Hereafter, the present invention is described with reference to FIG. 1. In the present invention, the term vibration refers to vibration of a globular valve element 7 in a valve main body 1, and does not include shaking and the like that occurs as a result of the flow of the fluid that does not directly involve the globular valve element 7, or as the result of other external forces.

In the present invention, it is necessary that the valve main body 1 have two opening parts. Furthermore, so long as the globular valve element is globular and functions as a valve element, it may have an ellipsoid shape or an eccentric shape, but it is preferable that this be a spherical ball shape.

In the present invention, the flow path opening area S₂ refers to the smaller of the two flow path opening areas that are formed between the holding ring 9 and the globular valve element 7 at a line that connects the center of gravity of the globular valve element 7 and the inner circumferential line of the seat ring 11 (seal point) or at a line that connects the center of gravity of the globular valve element 7 and the downstream inner circumferential line of the holding ring 9. In the case of the ball check valve in FIG. 1, the flow path opening area formed between the holding ring 9 and the globular valve element 7 at the line that connects the center of gravity of the globular valve element 7 and the downstream inner circumferential line of the holding ring 9 is smaller, and therefore constitutes the flow path opening area S₂.

In the present invention, it suffices that the material for seat ring 11 be a rubber-like elastic body, and while ethylene-propylene rubber, isoprene rubber, chloroprene rubber, chlorosulfonated rubber, nitrile rubber, styrene-butadiene rubber, chlorinated polyethylene, fluorine rubber and the like may be cited as suitable materials, there are no particular restrictions.

Furthermore, in the present invention, the materials for the main body 1, the globular valve element 7, the flanged short pipes 17, 24, the cap nuts 20, 25, the holding ring 9 and the pressing ring 14 of the ball check valve may be synthetic resins such as polyvinyl chloride (hereafter, written as PVC), polypropylene, polyvinylidene fluoride, polystyrene, ABS resin, polytetrafluoroethylene, tetrafluoroethylene-perfluoroalkyl vinyl ether copolymer and polychlorotrifluoroethylene, or metals such as iron, steel, copper, copper alloys, brass, aluminum and stainless steel.

The present invention, which is structured as described above, can achieve the following beneficial effect.

(1) Vibration of the globular valve element can be prevented when water is conducted by the ball check valve.
(2) As the distance over which the globular valve element travels is short, the ball check valve can be made compact.
(3) Because vibration of the globular valve element is prevented, noise due to vibration is eliminated, so that it is possible to limit noise when water is conducted.
(4) By preventing vibration of the globular valve element, it is possible to prevent reductions in flow rates, so that high Cv values are achieved, allowing large flow rates to be supported.
5) Because damage to the valve main body resulting from vibration of the globular valve element is prevented, the ball check valve can be used for long periods of time.

### BRIEF DESCRIPTION OF THE DRAWINGS

FIG. 1 is a longitudinal sectional view showing one mode of embodiment of the ball check valve of the present invention.

FIG. 2 is a sectional view according to A-A in FIG. 1.

FIG. 3 is an enlarged longitudinal sectional view of key parts in FIG. 1.

FIG. 4 is an enlarged cutaway perspective view of key parts, showing the flow path opening area S₂.

FIG. 5 is a graph showing characteristics for Cv value against S₂/S₁.

FIG. 6 is a longitudinal sectional view showing a conventional check valve.

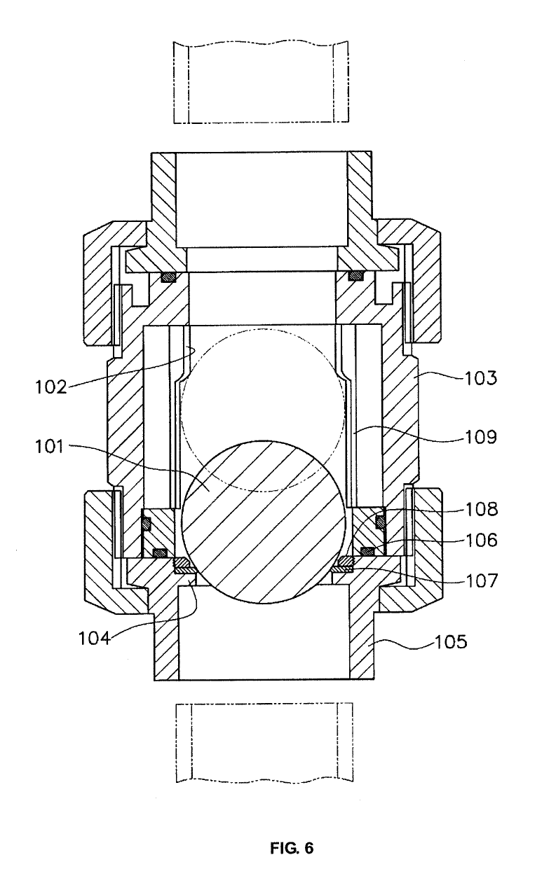

### DETAILED DESCRIPTION OF THE INVENTION

Hereafter, a mode of embodiment of the present invention is described based on the drawings, but it is a matter of course that the present invention is not limited to this mode of embodiment.

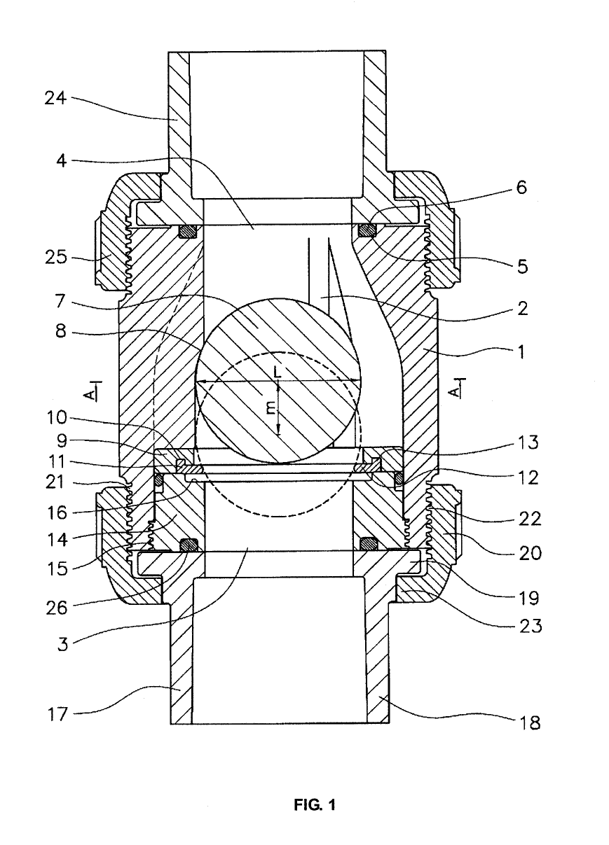

A substantially cylindrical hollow valve main body 1 is made from PVC, at the interior of which three elongate protrusions 2 are united with the valve main body 1, protruding in an evenly spaced radial manner, in line with the axis. The structure is such that: the aperture of an inlet opening part 3 on the upstream side (bottom side in FIG. 1) of the valve main body 1 is larger than the aperture of an outlet opening part 4 on the downstream side (topside in FIG. 1); and the interior of the valve main body 1 has a curved face that gradually narrows, somewhat downstream of the central region.

Furthermore, the elongate protrusions 2 are provided at a distance from the end face of the inlet opening part 3 of the valve main body 1, at a substantially uniform height with respect to the inner circumferential face of the inlet opening part 3, but in the vicinity of the outlet opening part 4, the heights thereof decrease gradually, so as to become substantially the same as the diameter of the outlet opening part 4.

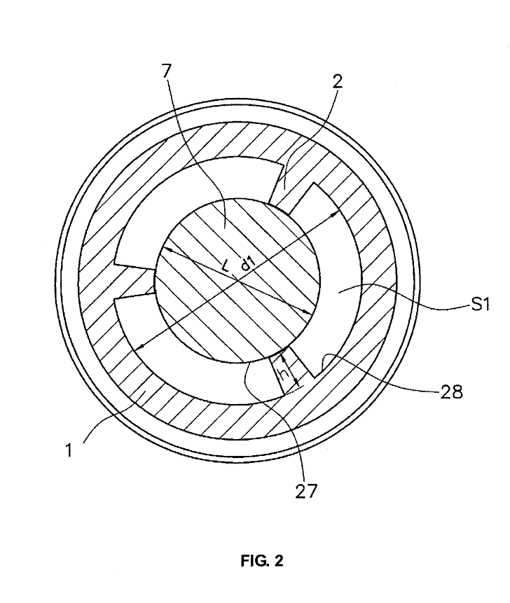

The height h of the elongate protrusions 2 with respect to the inner circumferential face of the valve main body 1 (portion at which these are provided at a substantially uniform height) is established so as to be 0.2 L with respect to the diameter L of the globular valve element 7. Note that the height h of the elongate protrusions 2 is preferably established at 0.1 L to 0.3 L, and more preferably 0.15 L to 2.5 L with respect to the diameter L of the globular valve element 7. In order to produce an opening area that allows for a sufficient flow of fluid, these elongate protrusions 2 must be no less than 0.1 L, and in order that the valve main body 1 not be excessively large and so that the fluid flow is caused to be linear, these elongate protrusions 2 must be no greater than 0.3 L. Note that, as shown in FIG. 2, three elongate protrusions 2 are provided at uniform intervals, but there is no particular limit on the number of elongate protrusions 2, so long as there are at least three elongate protrusions 2. From among these possibilities, the format in which three elongate protrusions 2 are provided is preferable because, even if there are dimensional errors in the elongate protrusions 2, it is possible to reliably hold the subsequently described globular valve element 7 in a three-point hold.

Furthermore, an annular groove 5 is provided on the end face of the outlet opening part 4 of the valve main body 1, and an O-ring 6 is fitted in the annular groove 5.

A globular valve element 7 is a ball made from PVC, and is held by the elongate protrusions 2 so as to allow reciprocating motion within the valve main body 1, along the axis thereof. The diameter of the globular valve element 7 is greater than that of the aperture of the outlet opening part 4 of the valve main body 1, so that when the globular valve element 7 is urged in the downstream direction by the flow of the fluid, it is held abutting stop faces 8 on the elongate protrusions 2. At this time, a distance m over which reciprocating motion of the globular valve element 7 is possible, which is to say, the travel distance of the center of gravity of the globular valve element 7 from the fully open position at which the globular valve element 7 abuts the stop faces 8 of the elongate protrusions 2, to the closed position at which the globular valve element 7 is at rest in contact with a subsequently described seat ring 11 (see FIG. 1), is formed so as to be 0.33 L with respect to the diameter L of the globular valve element 7.

Note that the distance m over which reciprocating motion of the globular valve element 7 is possible is preferably established within the range of 0.2 L to 0.6 L, and more preferably established within the range of 0.3 L to 0.45 L, with respect to the diameter L of the globular valve element 7. This is because, if the travel distance is excessively small, it is not possible to produce an opening area sufficient for flow of the fluid, and therefore this should be no less than 0.2 L so that the fluid flows in a manner ensuring a constant flow rate; but this should be no greater than 0.6 L in order that, without making the valve main body 1 excessively large, the globular valve element 7 can be constantly pressed against the stop faces 8 of the elongate protrusions 2 by the fluid pressure, without the globular valve element 7 being caused to vibrate. With this range of movement, it is possible to open and close the valve while minimizing the amount of motion of the globular valve element 7, and therefore the dimensions of the valve are minimized, allowing a compact valve to be produced.

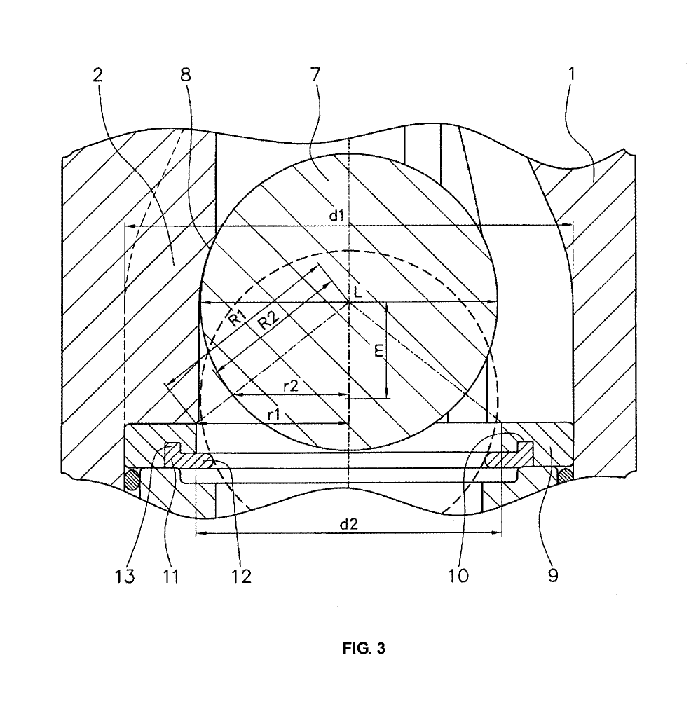

A holding ring 9 is an annular member made from PVC, the outer diameter thereof being substantially the same as the inner diameter at the end of the inlet opening part 3 of the valve main body 1, and is inserted via the inlet opening part 3 so that one end face thereof abuts the end faces of the elongate protrusions 2 that are oriented toward the inlet opening part 3. An annular groove 10, into which is fitted a subsequently described seat ring 11, is provided at the inner circumferential side of the other end face thereof. The inner diameter d2 of the holding ring is established so as to be 1.025 L with respect to the diameter L of the globular valve element 7. (See FIG. 3.) The inner diameter d2 of this holding ring 9 may be established so as to be 1.005 L to 1.040 L with respect to the diameter L of the globular valve element 7.

A seat ring 11 is made from rubber, and is formed in a sectional L shape with an integral annular fitting part 13 provided at the outer circumferential edge thereof, which protrudes in the axial direction of the valve main body 1, and an integral inner flange 12, which protrudes in the inner circumferential direction. The inner edge of the inner flange 12 has a sectionally arcuate shape, and is narrower than the inner diameter of the holding ring 9. Furthermore, the cylindrical annular fitting part 13 at the outer circumferential edge fits into the annular groove 10 in the holding ring 9.

A cylindrical pressing ring 14 is made from PVC, and a male threaded part 15 is formed at the outer circumference thereof, which threadedly engages with a female threaded part that is provided at the end of the inlet opening part 3 of the valve main body 1. By threadedly engaging the pressing ring 14 on the inlet opening part 3 of the valve main body 1, the holding ring 9, in which the seat ring 11 is fitted, is trapped between one end face of the pressing ring 14 and the ends of the elongate protrusions 2 that are oriented towards the inlet opening part 3, and held in a pressed state. A stepped portion 16 is formed at the inner circumferential side of one end face of the pressing ring 14, so that a gap is maintained between the pressing ring 14 and the inner flange 12 of the seat ring 11. When the inner flange 12 is thin, this gap is dimensioned so as to be equal to this thickness or less than this thickness, and is preferably formed in the range of 1 to 5 mm. Furthermore, the outer circumference of the pressing ring 14 is sealed against the inner circumference of the valve main body 1, with an O-ring therebetween, and an annular groove into which an O-ring 26 fits, is provided on the other end face of the pressing ring 14. Furthermore, the inner diameter of the pressing ring 14 is smaller than the diameter of the globular valve element 7, so that when the valve is closed, the globular valve element 7 is held by the pressing ring 14 so as not to come out.

A flanged short pipe 17 is made from of PVC, a flange 19 being provided at one end of a short pipe section 18, which is connected to a pipe or the like. Note that a flange part (not shown) may be provided on the other end of the short pipe section 18.

A cylindrical cap nut 20 is made from PVC and, at the inner circumference of one end thereof, is provided with a female threaded part 22 that is threadedly mounted on a male threaded part 21, the male threaded part 21 being provided on the outer circumference at both ends of the valve main body 1; at the other end of the cap nut 20 an inner flange 23 is provided, which protrudes in the inner circumferential direction. The cap nut 20 is threadedly mounted on the male threaded part 21 of the valve main body 1, with the end face of the flange 19 of the flanged short pipe 17 abutting the end face of the pressing ring 14 on the upstream side of the valve main body 1, with an O-ring 26 therebetween, so that the flanged short pipe 17 and the valve main body 1 are fixed in place in a sealed state.

Furthermore, in a similar fashion, at the downstream end of the valve main body 1, a flanged short pipe 24 abuts the end face of the valve main body 1, with an O-ring 6 therebetween, and the flanged short pipe 24 and the valve main body 1 are fixed in place in a sealed state by a cap nut 25.

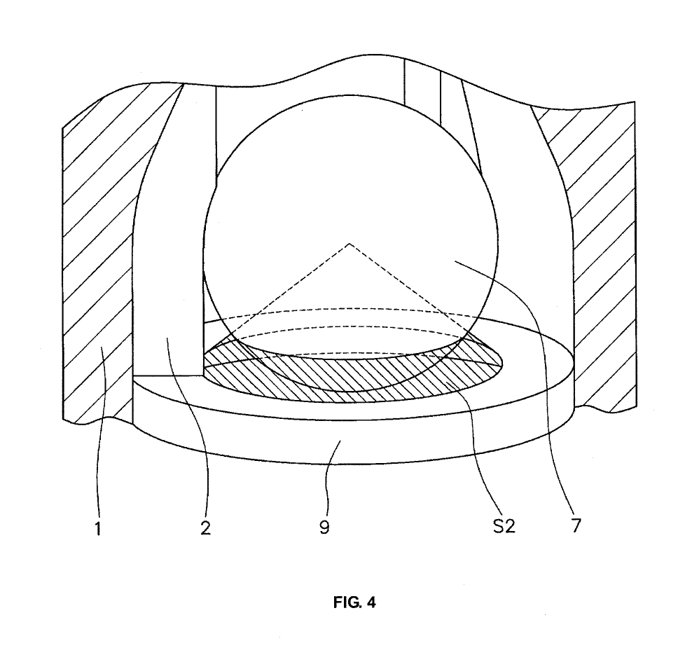

Here, the dimensional relationships in the ball check valve are described. When the globular valve element 7 abuts the stop faces 8 of the elongate protrusions 2 as indicated by the solid line in FIG. 1, the relationship between: the flow path opening area S₁ that is formed between the outer circumferential line 27 that is orthogonal to the axis at the center of gravity of the globular valve element 7 and the inner circumferential face 28 of the valve main body (the area of the portion that constitutes the flow path in FIG. 2); and the flow path area S₂ that is formed between the holding ring 9 and the globular valve element 7 at a line that connects the center of gravity of the globular valve element and the downstream inner circumferential line of the seat ring 11 or of the holding ring 9 (see FIG. 4) must be in a range that satisfies S₂=0.45 S₁ to 0.65 S₁, and more preferably must be such that S₂=0.53 S₁ to 0.63 S₁. This is because, 0.45 S₁ or more is necessary in order to obtain a flow path opening area sufficient for the flow rate not to be lowered, and 0.65 S₁ or less is necessary in order to maintain an urging force in order to constantly press the globular valve element 7 against the stop faces 8 of the elongate protrusions 2. Where d1 is the inner diameter of the valve main body and L is the diameter of the globular valve element (see FIG. 3), the flow path opening area S₁ is calculated as S₁=π/4×(d1²-L²)−(sectional area of the elongate protrusions)×(number of elongate protrusions); and where R1 is the distance from the center of gravity of the globular valve element 7 when the globular valve element 7 abuts the stop faces 8 of the elongate protrusions 2 to the downstream inner circumferential line of the holding ring 9, r1 is the distance from a position on said inner circumferential line to the center axis, R2 is the distance from the center of gravity of the globular valve element 7 to the outer circumferential face of the globular valve element 7, and r2 is the distance from a position on said outer circumferential face to the center axis (see FIG. 3), the flow path opening area S₂ is calculated as the surface area of the side face of the truncated cone where S₂=π×(R1×r1-R2×r2). Note that if the distance to the seal point of the seat ring 11 is less than the distance from the center of gravity of the globular valve element 7 to the downstream inner circumferential line of the holding ring 9, the area S₂ is calculated with the shorter distance as R1.

When the globular valve element 7 is in the closed position, at rest against the seat ring 11, the end faces of the elongate protrusions 2, against which the holding ring 9 abuts, are preferably located nearer to the inlet opening part 3 than the outer circumferential line 27 that is orthogonal to the axis at the center of gravity of the globular valve element 7. The reason for this is that it makes it possible to improve the responsiveness, so as to quickly open the flow path without a time lag occurring in the opening and closing of the valve, when the globular valve element 7 moves from the closed state towards the outlet opening part 4, and to achieve a large opening area with little movement of the globular valve element 7 and thus maintain the Cv value.

Note that, in the present mode of embodiment, the seat ring 11 is fitted in the holding ring 9, but the seat ring 11 and the holding ring 9 may be adjacent, without being fitted. (Not shown. In this case, the seat ring would have a different shape.) Furthermore, within the range in which the sealing properties are maintained, the inner flange 12 of the seat ring 11 may be made thin, and preferably the thickness thereof is in the range of 0.05 L to 0.1 L with respect to the diameter L of the globular valve element 7. This is because 0.05 L or more is desirable so that the seat ring 11 seals without major deformation, when the globular valve element 7 contacts the seat ring 11, and 0.1 L or less is desirable in order to prevent the globular valve element 7 from sinking into the seat ring 11.

Furthermore, in the present mode of embodiment, a pressing ring 14 is used, but the configuration may be such that a pressing ring 14 is not used (not shown). In this case, with the seat ring 11 and the holding ring 9 fitted together, the end face of the flange 19 of the flanged short pipe 17 is abutted against the seat ring 11, and the flanged short pipe 24 and the valve main body 1 are fixed in place in the sealed state by the cap nut 25.

Furthermore, a taper may be provided on the inner circumference of the holding ring 9, providing a brief constriction in the upstream direction (not shown). In this case, the globular valve element 7 abuts the taper so as to be held in the optimal position for sealing, without the globular valve element 7 sinking deeply into the seat ring 11. The angle of the taper is preferably 10° to 30° with respect to the axis; this should be no less than 10° so that the face-to-face dimensions of the ball check valve are not excessively large, and should be no greater than 30° so as to avoid damage to the globular valve element 7 by causing the globular valve element 7 to abut the inner circumferential face of the taper, without the forward end portion that has the minimal diameter striking the globular valve element 7. When a taper is provided, it is preferable that the constriction be such that the minimal diameter of the holding ring 9 (minimal diameter of the taper) be 0.9 L to 0.97 L with respect to the diameter L of the globular valve element 7. This should be 0.9 L or more, so as not to constrict the flow path within the bail check valve, and it should be 0.97 or less so that the globular valve element 7 reliably abuts the holding ring 9.

Next, operations during opening and closing of the ball check valve of the present invention will be described. When a fluid flows from the upstream side to the downstream side (forward flow, from the bottom to the top in FIG. 1), the globular valve element 7 moves to the position indicated by the solid line in FIG. 1, and the fluid flows downstream through the flow path formed between the globular valve element 7 and the elongate protrusions 2 in the valve main body 1. When the fluid from the upstream side stops, the globular valve element 7 moves to the upstream side, due to the backflow pressure of the fluid on the downstream side, and presses against the seat ring 11, resulting in a closed state in which backflow of the fluid is prevented (situation indicated by the dashed line in FIG. 1). In the closed state, the globular valve element 7 makes linear contact with the arcuate section of the inner circumferential edge of the inner flange 12 of the seat ring 11. As a result of forming a stepped portion 16 on the inner circumferential side on the one end of the pressing ring 14, when the globular valve element 7 abuts the seat ring 11, due to the gap between the seat ring 11 and the stepped portion 16, the seat ring 11 defects slightly toward the stepped portion 16, so that a seal can be achieved by way of the seat ring 11 making uniform linear contact on the outer circumferential face of the globular valve element 7. It is thus possible to prevent gaps from occurring due to dimensional errors in the seat ring 11, so that even if the backflow pressure is low, reliable sealing can be achieved, whereby fluid leaks are prevented. Furthermore, because the contact area is small, the frictional resistance between the globular valve element 7 and the seat ring 11 is reduced, which improves the separation of the globular valve element 7 from the seat ring 11 when the fluid begins forward flow, and allows for highly responsive opening and closing in response to the flow of the fluid, without a time lag occurring when the valve opens and closes. Furthermore, the deformation of the seat ring 11 in the region of the stepped portion 16 can be limited in the region of the stepped portion 16 so that the globular valve element 7 can be held, when the backflow pressure is high.

Here, when the fluid flows from the upstream side to the downstream side (forward flow, from the bottom to the top in FIG. 1), the fluid pushes the globular valve element 7 up, opening the flow path and flowing therethrough, so that the fluid flows out from the outlet opening part 4 by way of the flow path that is formed between the globular valve element 7 and the holding ring 9, which is to say, the flow path that is formed between the outer circumferential line 27 that is orthogonal to the axis at the center of gravity of the globular valve element 7 and the inner circumferential face 28 of the valve main body 1. At this time, the area S₂ of the flow path opening that is formed between the holding ring 9 and globular valve element 7 at the line that connects the center of gravity of the globular valve element 7 and the downstream inner circumferential line of the holding ring is established so as to be smaller than the area S₁ of the flow path opening formed between the outer circumferential line 27 that is orthogonal to the axis at the center of gravity of the globular valve element 7 and the inner circumferential face 28 of the valve main body 1, and thus the fluid that passes through the flow path opening area S₂ is at a greater fluid pressure on the upstream side than on the downstream side, and this, in combination with the flow of the fluid, results in urging with a strong force in the direction that pushes the globular valve element 7 up. While the fluid is flowing, the upwardly urging force is constantly maintained, and therefore a state is produced in which the globular valve element is constantly pressed against the stop faces of the elongate protrusions, and does not move due to disturbances in the fluid flow. Thus, vibration of the globular valve element 7 with respect to the axis of the valve main body 1 is prevented.

Next, the capacity coefficient, vibration and noise of the ball check valve of the present invention were evaluated by way of the test methods set forth below.

### (1) Capacity Coefficient Measurement Test

Based on the valve capacity coefficient (Cv value) test method in JIS B 2005-2-3 “Industrial process adjustment valves—Part 2: Flow volume—Section 3: Testing procedure,” with a vertical fitting in which the inlet opening part 3 was oriented downwards and the outlet opening part 4 was oriented upwards, a fluid was caused to flow from the bottom to the top, the pressure and flow volume on the upstream side and downstream side of the ball check valve were measured, and the capacity coefficient (Cv value) was calculated.

### (2) Checking for Vibration

A ball check valve that had been connected to pipes was touched directly with a hand, and whether or not vibration of the globular valve element occurred was determined by way of touch, excluding shaking that occurred when the fluid flowed.

### (3) Checking for Noise

Using a stethoscope, whether or not noise occurred due to vibration at the location at which the ball check valve was connected to the pipes was listened for, excluding sounds produced when the fluid flowed in the pipes.

Note that, a ball check valve having a nominal diameter of 40 mm was used in this test. Furthermore, based on the conditions of the piping used with the ball check valve, the standard value for capacity coefficient measurement tests with a nominal diameter of 40 mm was a Cv value of no less than 50, and the more preferred range was no less than 55.

### Working Example 1

The Cv value, vibration and noise were measured using the ball check valve of the present mode of embodiment wherein there is a relationship of S₂=0.45 S₁ between the area S₁ of the flow path opening formed between the outer circumferential line 27 that is orthogonal to the axis at the center of gravity of the globular valve element 7 and the inner circumferential face 28 of the valve main body 1 and the area S₂ of the flow path opening that is formed between the holding ring 9 and globular valve element 7 at the line that connects the center of gravity of the globular valve element 7 and the downstream inner circumferential line of the holding ring 9, when the globular valve element 7 is abutting the stop faces 8 of the elongate protrusions 2, as shown in FIG. 1. The test results are shown in Table 1.

### Working Example 2

In the same manner as in Working Example 1, the Cv value, vibration and noise were measured using the ball check valve of the present mode of embodiment wherein S₂=0.53 S₁. The test results are shown in Table 1.

### Working Example 3

In the same manner as in Working Example 1, the Cv value, vibration and noise were measured using the ball check valve of the present mode of embodiment wherein S₂=0.59 S₁. The test results are shown in Table 1.

### Working Example 4

In the same manner as in Working Example 1, the Cv value, vibration and noise were measured using the ball check valve of the present mode of embodiment wherein S₂=0.63 S₁. The test results are shown in Table 1.

### Comparative Example 1

In the same manner as in Working Example 1, the Cv value, vibration and noise were measured using the ball check valve of the present mode of embodiment wherein S₂=0.37 S₁. The test results are shown in Table 1.

### Comparative Example 2

In the same manner as in Working Example 1, the Cv value, vibration and noise were measured using the ball check valve of the present mode of embodiment wherein S₂=0.67 S₁. The test results are shown in Table 1.

### Comparative Example 3

In the same manner as in Working Example 1, the Cv value, vibration and noise were measured using the ball check valve of the present mode of embodiment wherein S₂=0.91 S₁. The test results are shown in Table 1.

TABLE 1

| | S₂/S₁ | Cv Value | Vibration | Noise |
|---|---|---|---|---|
| Working Example 1 | 0.45 | 51 | no | no |
| Working Example 2 | 0.53 | 57 | no | no |
| Working Example 3 | 0.59 | 59 | no | no |
| Working Example 4 | 0.63 | 58 | no | no |
| Comparative Example 1 | 0.37 | 41 | no | no |
| Comparative Example 2 | 0.67 | 47 | yes | yes |
| Comparative Example 3 | 0.91 | 38 | yes | yes |

As is clear from Table 1, while vibration and noise were not generated in the working examples or in Comparative Example 1, vibration and noise were generated in Comparative Examples 2 and 3. Furthermore, in terms of Cv values, while the working examples cleared the standard value of 50, with the comparative examples, the standard value was not satisfied. This is because, in Comparative Example 1, due to the opening area S₂ being excessively small, the fluid flow was poor and the Cv value was lowered. In Comparative Example 2 and Comparative Example 3, an opening area sufficient for flow of the fluid was obtained, but vibration was generated in the globular valve element 7, and thus the vibration of globular valve element 7 impeded the flow of the fluid, whereby the CV value was lowered.

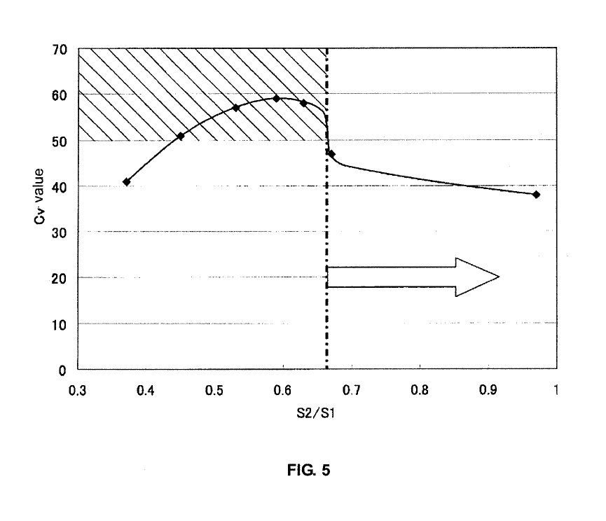

FIG. 5 shows characteristics for S₂/S₁ against Cv values, from FIG. 5 it can be seen that above a certain value for S₂/S₁, the Cv value suddenly drops; this is the boundary for generation of vibration. Consequently, within the range of S₂=0.45 to 0.65 S₁, wherein the cutoff line of a Cv value of 50 or more is satisfied (the diagonally hatched area in FIG. 5), the Cv value is high and good flow volume characteristics can be obtained, together with which it is possible to prevent the generation of vibration in the globular valve element 7 and to prevent noise. Moreover, within the range of S₂=0.53 to 0.63 S₁, higher Cv values can be obtained, which is more preferable. Thus, it is possible to eliminate vibration of the globular valve element 7 and noise so as to reduce wear of the globular valve element 7, and to achieve good flow volumes, making it possible to maintain good seal characteristics over long periods of time.

1. A ball check valve comprising: a cylindrical valve main body having two opening parts and provided on an inner face with axially oriented elongate protrusions; a holding ring, which is held on an upstream opening part of said valve main body, abutting end faces of said elongate protrusions; a seat ring, which is disposed adjacent to or fitted with said holding ring; and a globular valve element, which is held so as to be able to reciprocate between stop faces on said elongate protrusions and a valve-closed position, at rest in contact with said seat ring, wherein, when the globular valve element is abutting the stop faces of the elongate protrusions, the relationship between: the area S₁ of a flow path opening formed between an outer circumferential line that is orthogonal to an axis at a center of gravity of the globular valve element and an inner circumferential face of the valve main body; and the area S₂ of a flow path opening that is formed between the holding ring and the globular valve element at a line that connects the center of gravity of the globular valve element and a downstream inner circumferential line of the seat ring or the holding ring is S₂=0.45 S₁ to 0.65 S₁.

2. The ball check valve according to claim 1, wherein, a distance m over which said globular valve element can reciprocate is 0.2 L to 0.6 L, with respect to diameter L of said globular valve element.

3. The ball check valve according to claim 1, wherein, when said globular valve element is in the closed position, at rest against said seat ring, the end faces of said elongate protrusions that abut said holding ring are located further upstream in said valve main body than an outer circumferential line that is orthogonal to said axis at the center of gravity of said globular valve element.

4. The ball check valve according to claim 1, further comprising a pressing ring that threadedly engages on an inner circumferential face of the upstream opening part of said valve main body and holds said holding ring and said seat ring trapped against the end faces of said elongate protrusions.

5. The ball check valve according to claim 1, further comprising: a flanged short pipe, which is held in a sealed state against said valve main body with said seat ring or said pressing ring therebetween; and a cap nut that fixes said flanged short pipe in place on said valve main body by threadedly engaging on said valve main body.

6. The ball check valve according to claim 1, wherein an annular fitting part formed at an outer circumferential edge of said seat ring fits in an annular groove formed in a side face of said holding ring, and one end face of said pressing ring, or a flange-side end face of said flanged short pipe, abuts and presses against said seat ring.

7. The ball check valve according to claim 1, wherein a taper is provided on an inner face of said holding ring, which narrows to less than a diameter of said globular valve element.

8. The ball check valve according to claim 1, by further comprising: an O-ring fitted in an annular groove that is provided on an end face of a downstream opening part of the valve main body; a flanged short pipe that contacts said valve main body with said O-ring therebetween; and a cap nut that fixes said flanged short pipe in place on said valve main body by threadedly engaging on said valve main body.
